(19) United States
(12) Patent Application Publication
(10) Pub. No.: US 2006/0009103 A1
(43) Pub. Date: Jan. 12, 2006

(54) Air permeable and waterproof stretchable woven fabric

(75) Inventor: Kuo Chin Chen, Sinjhuang City (TW)

Correspondence Address: TROXELL LAW OFFICE PLLC, SUITE 1404, 5205 LEESBURG PIKE, FALLS CHURCH, VA, 22041, US

(73) Assignee: Singtex Industrial Co. , Ltd.

(21) Appl. No.: 10/885,625

(22) Filed: Jul. 8, 2004

(51) Int. Cl. B32B 27/04

(52) U.S. Cl. 442/79

(57) ABSTRACT

The present invention is an air permeable and waterproof stretchable woven fabric. It is a multi-functional woven fabric comprising the following processes: warping and weaving the warps and the wefts to obtain a gray fabric; adding stretchable yarns into the warps and the wefts; and, dyeing and finishing the gray fabric. Accordingly, without coating with or laminating rubbers or films, the fabric can obtain elasticity and better stretchability in the directions of the longitude or the latitude or both and is also waterproof and highly air permeable.

### FIELD OF THE INVENTION

The present invention relates to an air permeable and waterproof stretchable woven fabric. More particularly, the present invention relates to an air permeable and waterproof stretchable woven fabric without coating with or laminating rubbers or films, the woven fabric can still obtain elasticity and better stretchability in the directions of the longitude and the latitude and can be waterproof and highly air permeable.

### DESCRIPTION OF THE RELATED ART

The technology of air woven fabric has progressed a lot during the past years, so the role of air permeable and waterproof woven fabric is becoming increasingly important. Traditionally, the prior art of fabric usually utilizes the technique of coating or laminating to obtain waterproofing and air permeability, like the European patent ‘EP 1 316 634 A1’, which is achieved by that the interval mesh size of the rubber or the film is smaller than that of the water and bigger than that of the air. Because the fabric is processed with a regular single layer cloth, the working hour and the cost is increased; so is the thickness and the weight; and a hardness of hand feel shows.

Moreover, the water pressure resistance of the high density fabric without coating or laminating improves a lot now to a value of 600˜1300 mm/H₂O. (‘mm’ means ‘millimeter’.) But, because it is not stretchable, the clothes made of it provide no stretchability and less comfort on wearing it.

Beside the above shortages of the two prior arts, their C.F. (cover factor) value, stretchability, C.F.S. (cover factor stretch) value, water vapor permeability, water pressure resistance, water repellence, and air permeability is not desirable. So, the related arts do not fulfill users' requests on actual usage.

### SUMMARY OF THE INVENTION

Therefore, the main purpose of the present invention is that, without coating with or laminating rubbers or films, the woven fabric can obtain elasticity and better stretchability in the directions of the longitude and the latitude and can be also waterproof and highly air permeable.

To achieve the above purposes, the present invention is an air permeable and waterproof stretchable woven fabric comprising the following processes: warping and weaving the warps and the wefts to obtain a gray fabric; adding stretchable yarns into the warps and the wefts of the gray fabric to obtain elasticity in the directions of the longitude and the latitude and to obtain better stretchability; and, dyeing and finishing the gray fabric to obtain a gray fabric with waterproofing and high air-permeability. Without coating with or laminating rubbers or films, the fabric can obtain elasticity and better stretchability in the directions of the longitude and the latitude and can be waterproof and highly air permeable.

### BRIEF DESCRIPTION OF THE DRAWINGS

The present invention will be better understood from the following detailed description of preferred embodiments of the invention, taken in conjunction with the accompanying drawings, in which:

FIG. 1 is a cross-sectional view of the structure on the longitude direction according to the present invention;

FIG. 2 is a cross-sectional view of the structure on the latitude direction according to the present invention;

FIG. 3 is a view of the dyeing heat-up curve according to the present invention;

FIG. 4 is a flow chart of the preparatory fixing according to the present invention;

FIG. 5 is a flow chart of the post fixing according to the present invention; and

Table 1 is a comparison table showing result data of the experiments on (1) the present invention; (2) regular density with stretchability; (3) high density without stretchability.

### DETAILED DESCRIPTION OF THE PREFERRED EMBODIMENTS

The following descriptions of the preferred embodiments are provided to understand the features and the structures of the present invention.

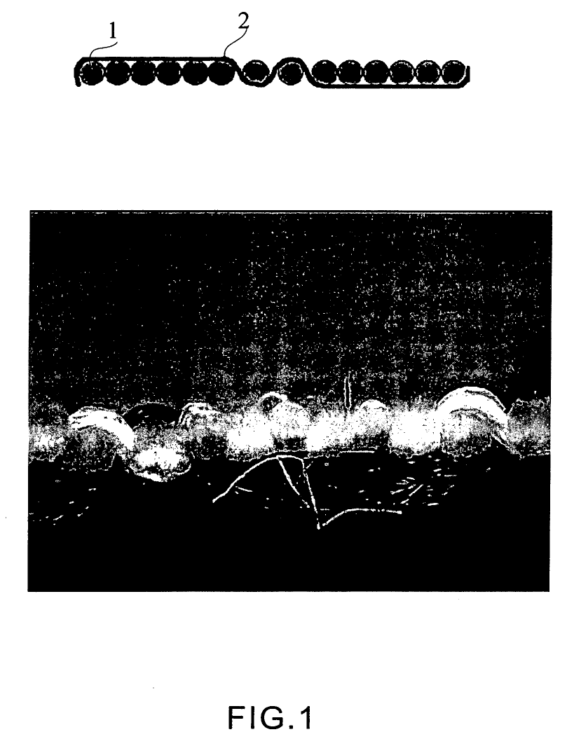

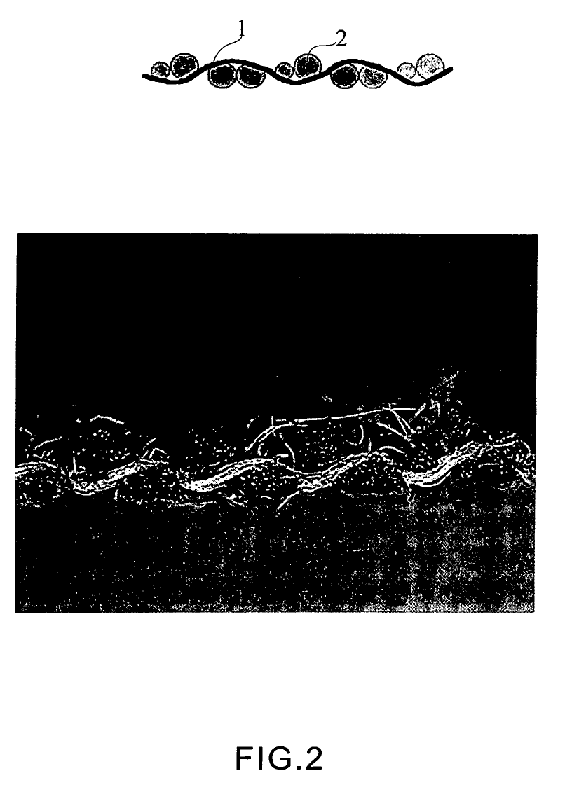

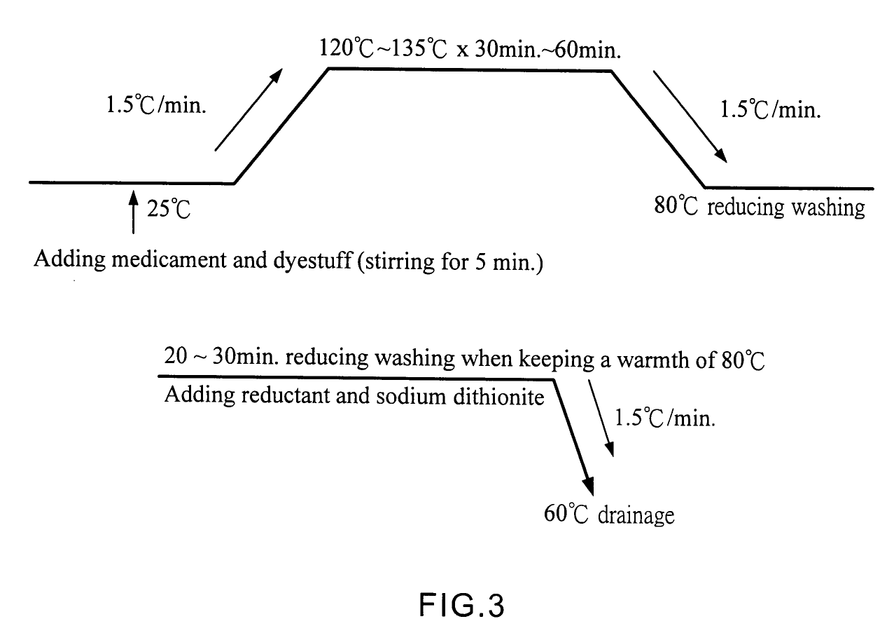

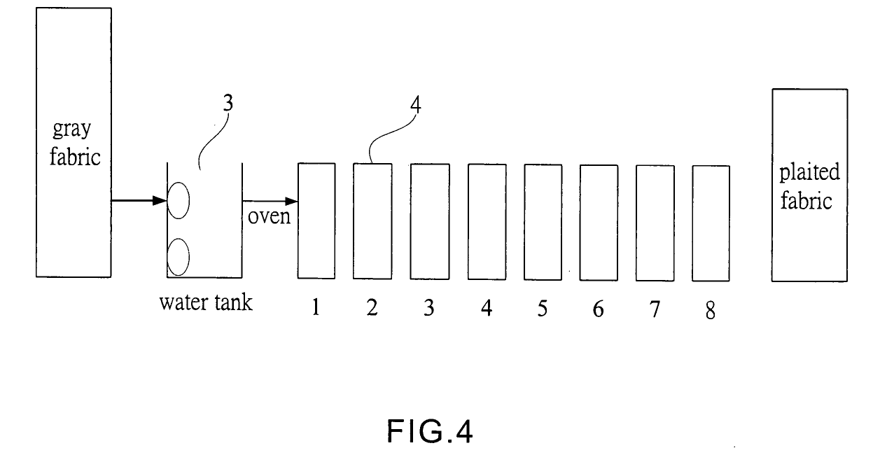

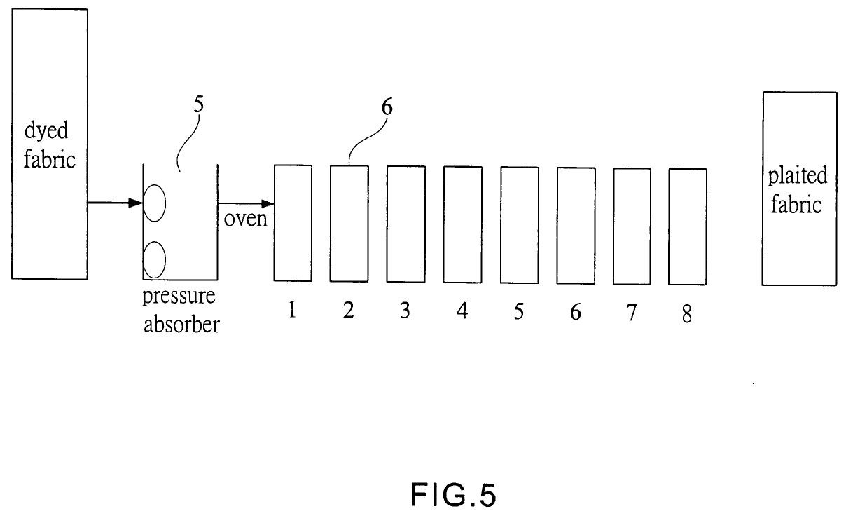

Please refer to FIG. 1 through FIG. 5, which are a cross-sectional view of the structure on the longitude direction, a cross-sectional view of the structure on the latitude direction, a view of the dyeing heat-up curve, a flow chart of the preparatory fixing and a flow chart of the post fixing, according to the present invention. As shown in the figures, the present invention is an air permeable and waterproof stretchable woven fabric whose warps 1 and wefts 2 are warped and woven to obtain a gray fabric. The warping process comprises steps of winding, warping, lapping, warp beaming, starching, lapping, doubling, and cloth warp beaming. The weaving process comprises steps of cloth warp beaming, harnessing, weaving, installing drop wire, setting up the weaving parameters, and obtaining high-density fabric (gray fabric). The gray fabric with high coverage is obtained through controlling the density by the weaving process. Stretchable yarns are added into the warps 1 and the wefts 2 of the gray fabric to obtain elasticity in the directions of the longitude and the latitude and to obtain better stretchability, wherein FIG. 1 shows the cross-sectional view on the longitude direction and FIG. 2 shows the cross-sectional view on the latitude direction. Then the gray fabric is processed with dyeing and finishing. The dyeing-and-finishing process comprises steps of desizing, refining, preparatory fixing, dyeing, drying, and post fixing and finishing. Or, it may comprise steps of fixing, desizing, refining, dyeing, drying, and post fixing and finishing. Or, it may comprise steps of obtaining gray fabric, desizing, refining, preparatory fixing, dyeing, drying, intermediate inspecting, fixing, post inspecting, and packing. Therein, the temperature for the desizing is between 80° C. (Celsius degree) and 100° C. where its speed is between 30 m/min and 50 m/min. (‘° C. ’ means ‘Celsius degree’; ‘m’ means ‘meter’; and ‘min’ means ‘minute’.) The temperature for the preparatory fixing is between 170° C. and 200° C. where its speed is between 30 m/min and 55 m/min. The dyeing can be done by using liquid-overfeed dyeing machine or air-flow dyeing machine. When processing the dyeing with a heat-up around 120° C. to 135° C. for 30 min to 60 min, it starts by adding medicaments at 25° C.; then the temperature is heated up till around 120° C. to 130° C. at a speed of 1.5° C. per minute; then the temperature is kept on for around 30 min to 60 min; then the temperature is cooled down to 80 ° C. at a speed of 1.5° C. per minute; then reductant and sodium dithionite are added for deterging; and then a drainage is processed when the temperature reaches down at 60° C. (As shown in FIG. 3). ¤@¤@ The temperature for the drying is between 110° C. and 130° C. where its speed is between 40 m/min and 55 m/min. The temperature for the post fixing is between 160° C. and 190° C. where its speed is between 30 m/min and 50 m/min. When processing the preparatory fixing, the fabric is wetted through a water tank 3 and is passed through a plurality of ovens 4 and then is plaited (As shown in FIG. 4). When processing the post fixing, the fabric is passed through a pressure absorber 5 which comprises water repellent to make the fabric capable of water repellence; then the fabric is passed through a plurality of ovens 6; and then the fabric is plaited (As shown in FIG. 5). So forth, the gray fabric becomes a fabric with waterproofing and high air-permeability. The fabric is a synthetic fiber comprised of textured yarns, wherein its C.F. (cover factor) value is between 2500 and 4200 and its C.F.S. (cover factor stretch) value is between 15000 and 35000. Through experiments, its stretch-and-recovery ratio is between 75% and 95% (ASTM D4964 under a stretch ratio of 30%); the ratio for its stretchability is between 10% and 35% (ASTM D3107); and its water vapor permeability is between 6000 gm/m²/24 hrs and 9000 gm/m²/24 hrs (JIS L1099 A1) or between 15000 gm/m²/24 hrs and 35000 gm/m²/24 hrs(JIS L1099 B1). (‘gm’ means ‘gram’ and ‘hrs’ means ‘hours’.) The fabric is water repellent with a value above 90 (AATCC 22) even after thirty times of washing (AATCC 135). It can pass the RAIN TEST (AATCC 35). Its water pressure resistance remains the same even after washing (AATCC 135). Its air-permeability is between 1.5 cm³/cm²/S and 11 cm³/cm²/S. (‘cm’ means ‘centimeter’ and ‘S’ means ‘second’.) Accordingly, a novel air permeable and waterproof stretchable woven fabric is obtained.

Please refer to table 1, which is a table showing the result data of the experiments according to (1) the present invention, (2) a regular density with stretchability, and (3) a high density without stretchability. According to the data shown in the table 1, the fabric made according to the present invention is better than the stretchable fabric with regular density and the non-stretchable fabric with high density on C.F. value, stretchability, C.F.S. value, water vapor permeability, water pressure resistance, water repellence, and air permeability. Hence, by referring to the table 1, the present invention can obtain elasticity and better stretchability in the directions of the longitude or the latitude or both and can be waterproof and highly air permeable without coating or laminating rubbers or films.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. An air permeable and waterproof stretchable woven fabric comprising processes of:
(a) warping and weaving the warps and the wefts to obtain a gray fabric;
(b) adding stretchable yarns into the warps and the wefts of said gray fabric to obtain elasticity in the directions of the longitude and the latitude and to obtain better stretchability; and
(c) dyeing and finishing said gray fabric,
wherein said dyeing and finishing comprises: desizing, refining, preparatory fixing, dyeing, drying, and post fixing and finishing.

2. The fabric according to claim 1, wherein said warping comprises: winding, warping, lapping, warp beaming, starching, lapping, doubling, and cloth warp beaming.

3. The fabric according to claim 1, wherein said weaving comprises: cloth warp beaming, harnessing, weaving, installing drop wire, setting up the weaving parameters, and obtaining high-density fabric (gray fabric).

4. The fabric according to claim 1, wherein said gray fabric is obtained having high coverage through controlling density by said weaving.

5. The fabric according to claim 1, wherein, when processing said preparatory fixing, said gray fabric is wetted through a water tank and is passed through a plurality of ovens and then is plaited.

6. The fabric according to claim 1, wherein, when processing said post fixing, said gray fabric is passed through a pressure absorber which comprises water repellent to make said gray fabric capable of water repellence; said gray fabric is passed through a plurality of ovens; and then said gray fabric is plaited.

7. The fabric according to claim 1, wherein the temperature for said desizing is between 80° C. (Celsius degree) and 100° C. and the speed for said desizing is between 30 m/min (meter per minute) and 50 m/min.

8. The fabric according to claim 1, wherein the temperature for said preparatory fixing is between 170° C. and 200° C. and the speed for said preparatory fixing is between 30 m/min and 55 m/min.

9. The fabric according to claim 1, wherein said dyeing process is done by using a liquid-overfeed dyeing machine.

10. The fabric according to claim 1, wherein said dyeing process is done by using an air-flow dyeing machine.

11. The fabric according to claim 1, wherein, when processing said dyeing with a heat-up around 120° C. to 135° C. for 30 min to 60 min, said dyeing starts by adding medicaments at 25° C.; then the temperature is heated up till around 120° C. to 130° C. at a speed of 1.5° C. per minute and the temperature is held for about 30 min to 60 min; then the temperature is cooled down to 80° C. at a speed of 1.5° C. per minute; then reductant and sodium dithionite are added for deterging; and then a drainage is processed when the temperature reaches down at 60° C.

12. The fabric according to claim 1, wherein the temperature for said drying is between 110° C. and 130° C. and the speed for said drying is between 40 m/min and 55 m/min.

13. The fabric according to claim 1, wherein the temperature for said post fixing is between 160° C. and 190° C. and the speed for said post fixing is between 30 m/min and 50 m/min.

14. ¤G¤G The fabric according to claim 1, wherein the C.F. (cover factor) value of said gray fabric is between 2500 and 4200 and the C.F.S. (cover factor stretch) value of said gray fabric is between 15000 and 35000.

15. The fabric according to claim 1, wherein said dyeing and finishing comprises: fixing, desizing, refining, dyeing, drying, and post fixing and finishing.

16. The fabric according to claim 1, wherein said dyeing and finishing comprises: obtaining gray fabric, desizing, refining, preparatory fixing, dyeing, drying, intermediate inspecting, fixing, post inspecting, and packing.

17. The fabric according to claim 1, wherein the stretch-and-recovery ratio of said gray fabric is between 75% and 95%; the stretchability ratio of said gray fabric is between 10% and 35%; and the water vapor permeability of said gray fabric is between 600 gm/m²/24 hrs (gram per square meter per 24 hours) and 9000 gm/m²/24 hrs.

18. The fabric according to claim 17, wherein the water vapor permeability of said gray fabric is between 15000 gm/m²/24 hrs and 35000 gm/m²/24 hrs.

19. The fabric according to claim 1, wherein the water repellence of said gray fabric has a value above 90 even after thirty times of washing.

20. The fabric according to claim 1, wherein said gray fabric is able to pass RAIN TEST and the water pressure resistance of said gray fabric remains the same even after washing.

21. The fabric according to claim 1, wherein the air-permeability of said gray fabric is between 1.5 cm³/cm²/S (cubic centimeter per square centimeter per second) and 11 cm³/cm²/S.

22. The fabric according to claim 1, wherein said gray fabric is a synthetic fiber comprised of textured yarns.
